(19) United States
(12) Patent Application Publication
(10) Pub. No.: US 2010/0003102 A1
(43) Pub. Date: Jan. 7, 2010

(54) Mechanical Blind Expansion Board-Anchor

(76) Inventors: Hitoshi Nagaiwa, Saitama (JP); Atsuko Nagaiwa, Saitama (JP)

Correspondence Address: EDWARDS ANGELL PALMER & DODGE LLP, P.O. BOX 55874, BOSTON, MA, 02205, US

(21) Appl. No.: 12/097,028

(22) PCT Filed: Dec. 13, 2006
(86) PCT No.: PCT/JP2006/324816

§ 371 Date: Jun. 11, 2008

(30) Foreign Application Priority Data
Dec. 14, 2005 (JP) 2005-360363

(51) Int. Cl. F16B 13/06

(52) U.S. Cl. 411/80.1

(57) ABSTRACT

In the mechanical blind expansion anchor-bolt, the inner plug insertion space in which the inner plug is inserted is formed in the outer sleeve body of the outer sleeve. The female screw, the diameter of which is reduced from the end face by the side of the inner plug flange toward the tip point of the inner plug expansion part, is formed in the inside of the inner plug expansion part of the inner plug. The inner plug is inserted in the inner plug insertion space of the outer sleeve, and the screw of the bolt is inserted in the female screw of the inner plug. After that, by carrying out the screwing of the bolt, the expansion of the inner plug expansion part is carried out, so that the expansion of the outer sleeve expansion part is carried out.

### BACKGROUND OF THE INVENTION

1. Field of the Invention

The present invention relates to a mechanical blind expansion board-anchor, and especially relates to a mechanical blind expansion board-anchor suitable for the hollow construction and the plate-shaped building materials.

2. Description of a Related Art

There are some which are shown below, as a mechanical board-anchor prepared to the hollow construction and the plate-shaped building materials.

### (1) The Attachment Bolt for Hollow Constructions Disclosed in JP-A-11-44311.

In the attachment bolt, the metal plate named “fastening blade” is inserted in the base material (plate material), and is displaced to the rectangular cross to the bolt axis on the back side of the base material. After that, according to the screwing, it is locked up with this fastening blade, the front side washer and the nut sandwiching the base-material wall.

### (2) The Board-Anchor Disclosed in JP-A-2003-42124.

In the board-anchor, the hollow metal with the slit parallel to the axis bends from the slit intermediate position on the back side of the base material and changes, and locks up by the sandwiches action with the washer attached to the front side screw according to the screwing action.

### (3) The Fastener Disclosed in JP-A-2003-232318.

However

(1) In the attachment bolt for hollow constructions disclosed in JP-A-11-44311, it cannot be enlarged according to the limits on the dimension of the frame-work hinge member. Therefore, since it has only vulnerable proof stress by the small materials, there is fear of omission from the hinge part.
(2) In the board-anchor disclosed in JP-A-2003-42124, since it must manufacture with the thin metal at which it can turn in the intermediate point part, it has only too vulnerable proof stress. Moreover, especially the shear proof stress is poor because of the fastening on the screw with the thin aperture.
(3) In the fastener disclosed in JP-A-2003-232318, the friction action with the sleeve and the plug driven in the sleeve from front is locked up. However
(a) It seems that the screwing of the screw has done the expansion action apparently, but it is the load realized in fact because the raw material of the sleeve and the plug changes. Therefore, the expansion effect by bolt screwing action does not occur.
(b) Moreover, it is effective in having prevented that the expansion situation returns to the taper-off situation after the screw screwing. However, the cone angle, sleeve, and plug expansion angle of the screw are this angle mostly. Therefore, the friction action or expansion action does not break out, either. Therefore, the anchor proof stress is not generated, either.

In order to acquire the stronger anchor proof stress, the following points are important.

1. Use not a screw but a bolt with a thicker aperture.
2. Or adopt a screw or a bolt without a taper.
3. Moreover, don't give damages, such as a shock and compression, to a base-material in all the stage of work, such as the time of anchor insertion and an expansion.

Moreover, each of the objects disclosed in JP-A-11-44311, JP-A-2003-42124 and JP-A-2003-232318 is premised on the shock and compression to the base-material.

For example,

(1) In the attachment bolt for hollow constructions disclosed in JP-A-11-44311, the base-material (wall material) is sandwiched in the fastening blade metal thickness section. However, since the fastening blade metal thickness section causes the action of the cutting edge, brittle materials, such as a gypsum board, cannot bear the variation rate of the fastening blade. Therefore, it is easily hidden in the base-material, and results in the base-material break-down.
(2) In the anchor for boards disclosed in JP-A-2003-42124, the anchor proof stress is acquired by that the metal piece penetrated on the board back side bends. However, since the area to which the metal piece touches the board is very narrow, it has only weak proof stress. Moreover, this metal piece resists the tensile stress by making the circumference of the screw into the fulcrum. However, there is nothing that is supported in the outer-edge end collapsed by bending. Moreover, because the soft metal is used, it can pull up and the accident occurs easily. Moreover, the accident which is hidden in the base-material also occurs easily.
(3) In the fastener disclosed in JP-A-2003-232318, in the time of the sleeve and the plug insertion shock, the partial loading capacity is momentarily applied to the drilling of the base-material. Moreover, it is premised on the method of also shock the structure top.

The above defect is pointed out also in JP-U-6-76503.

### SUMMARY OF THE INVENTION

The object of the present invention is to provide a mechanical blind expansion boar-anchor which is capable of improving the anchor strength in order to realize the anchor product and the anchor fastening method which can abolish completely the shock action and compression action causing the tissue breakdown of the base material.

A mechanical blind expansion boar-anchor of the present invention comprises: an outer sleeve (10) comprising an outer sleeve body (11), an outer sleeve flange (12) formed in an end face of the outer sleeve body, and an outer sleeve expansion part (13) formed in another end face of the outer sleeve body; an inner plug (20) comprising an inner plug expansion part (21), and an inner plug flange (22) formed in an end face of the inner plug expansion part; and a bolt (30), wherein an inner plug insertion space (18) in which the inner plug is inserted is formed in the outer sleeve body of the outer sleeve; a female screw part (24), a diameter of which is reduced from the end face by a side of the inner plug flange of the inner plug expansion part toward a tip part (21a) of the inner plug expansion part, is formed inside of the inner plug expansion part of the inner plug; the inner plug expansion part is expanded by inserting the inner plug in the inner plug insertion space of the outer sleeve, inserting a screw part of the bolt in the female screw part of the inner plug, and screwing the bolt, thereby the outer sleeve expansion part is expanded.

Further, a mechanical blind expansion boar-anchor of the present invention comprises: an outer sleeve (10) including an outer sleeve body (11), and an outer sleeve expansion part (13) formed in an end face of the outer sleeve body; an inner plug (20) including an inner plug expansion part (21); and means for expanding the inner plug expansion part of the inner plug, wherein an inner plug insertion space (18) in which the inner plug is inserted is formed in the outer sleeve body of the outer sleeve.

Here, the mechanical blind expansion board-anchor is be made of glass-reinforced plastics.

The outer sleeve expansion part has a cone-like shape; an outer sleeve drilling blade (15) is formed in a circumferential face of the outer sleeve expansion part; and an outer sleeve drilling spirally-concave-carved part (16) is formed from a boundary of the outer sleeve expansion part and the outer sleeve body to a central part of the outer sleeve body.

An outer sleeve base-material anchoring stage part (17) is formed in a circumferential surface of an intermediate part of the outer sleeve body; and a diameter of the outer sleeve body is reduced from the end face by a side of the outer sleeve flange of the outer sleeve body toward the outer sleeve base-material anchoring stage part.

An outer sleeve skid-prevention nail (19a) is formed in a face by a side of the outer sleeve body of the outer sleeve flange.

An inner plug skid-prevention nail (26) is formed in a face by a side of the inner plug expansion part of the inner plug flange; an inner plug flange insertion hole (19b), in which the inner plug flange is inserted, is formed in the outer sleeve flange; and an outer sleeve skid-prevention concave part (19a), in which the inner plug skid-prevention nail is inserted, is formed in an end face by a side of the outer sleeve flange of the outer sleeve body.

The mechanical blind expansion boar-anchor of the present invention applies “expansion dovetail anchor”, which is disclosed in the specification of Japanese Patent Application No. 2005-228385 (JP-A-2007-46229) filed by us, to a circular-hole-drilling-system board anchor.

In the tension test based on JP-A-2007-46229, it confirmed that the fact which an anchor expands certainly at the bottom of an anchor hole brought a result which anchor proof stress reinforces dramatically. This safer trustworthy expansion structure is applied to a board anchor.

In the case of the conventional circular hole anchor for concretes.

It is locking up only by the inside frictional force of a pore. Therefore, it is the camouflage anchoring which is not in an expansion situation actually. Therefore, even if anchor proof stress works normally, the feature of a break-down falls out and is phenomenon=“a corn break-down.” In the case of JP-A-2007-46229 on the other hand

The “crack break-down” from which it is going to escape on the base-material back side which met on the expansion angle extension appeared. This break-down means having acquired the proof stress proportional to base-material thickness. And the greatest result of this dovetail anchor is that “omission accident” which occurs in the conventional circular whole anchor is completely avoidable.

Moreover, in order to realize anchor installation in the work environment by which a hand does not go into the base-material back side.

Anchor proof stress is demonstrated by locking up the slack type component which consists of one or more using a blind-rivet system. Therefore, the present invention can be said to be what is called a “mechanical blind expansion board anchor” expanded in connection with a bolt screwing.

The mechanical blind expansion board-anchor of the present invention has the following effects.

(1) It can avoid the partial load to the base material and the omission accident by the anchor shank surrender which are the problems in the conventional technology mentioned above, and can improve the anchor proof stress in proportion to the stiffener of the base material. For example, the back of a board is reinforced using lattice-like metal or the steel flat bars which opened the pore beforehand, the angle steel, etc. And one reinforced lattice is used as the support building frame of an anchor. Thereby, the direct load to a base-material wall is imitable. For example, this reinforcement is given to the reinforced plaster board currently used abundantly at the medium and high-rise building. And it is useful as an anchoring and hanging of the inside heavy load of a control console, a vending machine, an air conditioner device, etc. As mentioned above, the effect of acquisition of the anchor proof stress felt easy and stabilized enables dramatic reduction which is an anchor number which needs to be beforehand prepared to the slab which constitutes the building frame of a floor or a ceiling. Furthermore, the weight saving of construction period shortening and a building is realized.
(2) By using reinforced plastic for a plate-shaped base material, anchor proof stress can be acquired by the reinforced strength. Or it becomes possible to count backward from the practical use strength needed, and to set up the plate-shaped thickness and weight of a base material. A construction like an airplane besides a building also makes a weight saving possible.
(3) This anchor can be used also for wood square bars, such as 2×4, besides various boards. Although this anchor puts a tool and a hand into the back side of a board, it makes possible the fastening and bolting of material in difficult environment. Woody family line board (an insulation board, a fiberboard, a temper board, a particle board, a lumber core, laminated veneer lumber and an orientation board, wafer board) Cement system board (a silicic acid calcium board, a flexible board, a wood-wool cement board, a gypsum board, a sheathing board, reinforced plaster board, a gypsum lath board, decorated plaster board, the hole aperture board for sound absorption, a compound gypsum board)
(4) As an option, an outer sleeve expansion part (13, 13′) is molded in one with a suitable metal for the twist-drill edge of a blade. This is the purpose of omitting the drilling of a prepared hole. Or a cutting edge prepares the pocket in which a plug is possible in an outer sleeve expansion part (13, 13′). The disposable object of the cutting edge to be used is more convenient.

A self-drilling-type anchor is realized by the above.

### BRIEF DESCRIPTION OF THE DRAWINGS

FIGS. 1A and 1B are drawings showing the composition of the mechanical blind expansion board-anchor according to the embodiment of the present invention, FIG. 1A is a drawing showing the composition of the outer sleeve 10, and FIG. 1B is a drawing the composition of the inner plug 20.

FIGS. 2A and 2B are drawings showing the application method of the mechanical blind expansion board-anchor according to the embodiment of the present invention, and are sectional drawings for explaining the insertion of the inner plug 20 into the outer sleeve 10.

FIGS. 3A and 3B are drawing showing the application method of the mechanical blind expansion board-anchor according to then embodiment of the present invention, FIG. 3A is a sectional drawing explaining the screwing of the bolt 30, FIG. 3B is a back plan thereof, and FIG. 3c is a surface plan thereof.

FIGS. 4A and 4B are drawing showing the application method of the mechanical blind expansion board-anchor according to then embodiment of the present invention, FIG. 4A is a sectional drawing explaining the expansion action of the mechanical blind expansion board-anchor, and FIG. 4B is a back plan thereof.

FIG. 5 is a drawing showing a composition example of the outer sleeve 10′ when not having the self-drilling function.

### DESCRIPTION OF THE PREFERRED EMBODIMENTS

Now, an embodiment of a mechanical blind expansion board-anchor according to the present invention will be described in detail with reference to the drawings.

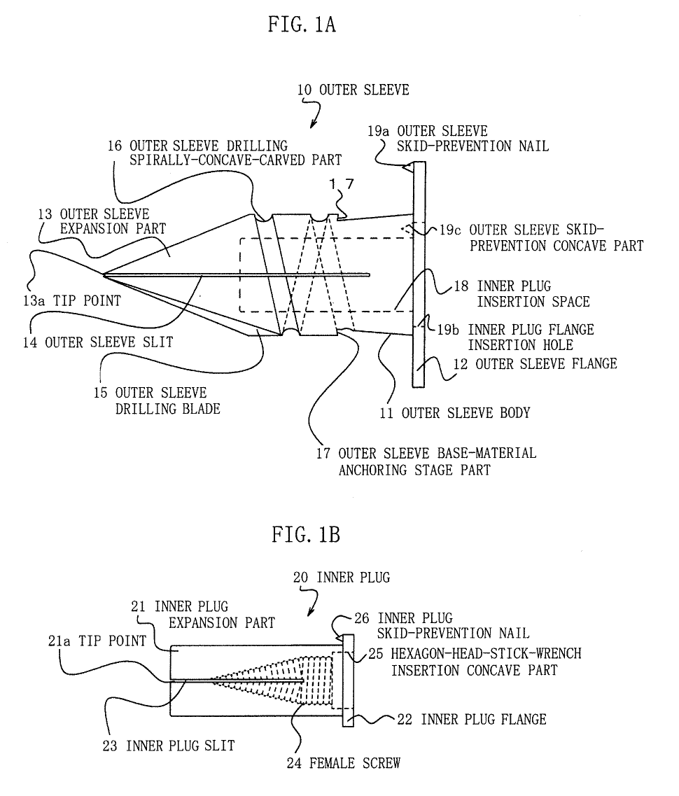

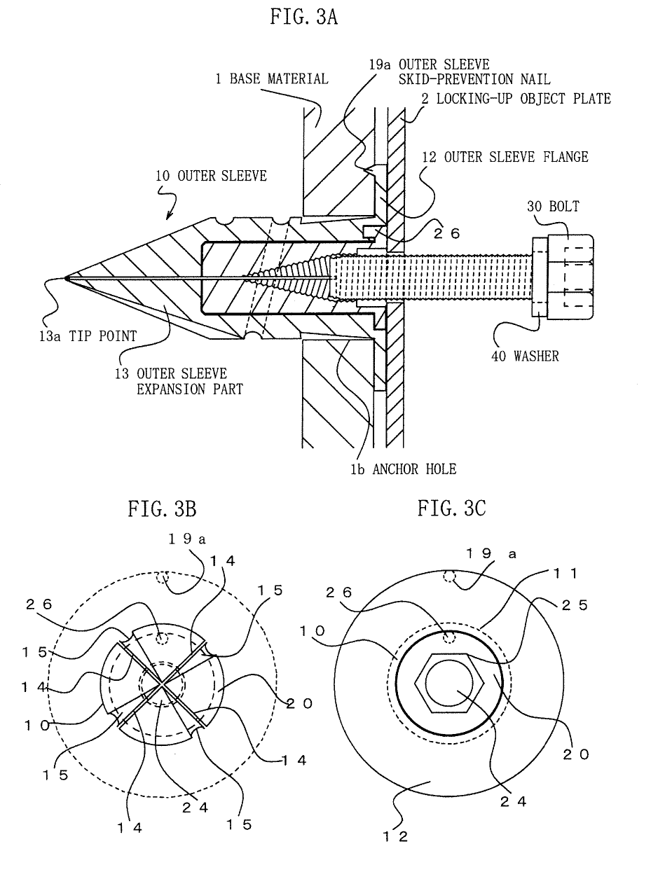

A mechanical blind expansion board-anchor according to an embodiment of the present invention comprises an outer sleeve 10 shown in FIG. 1A, an inner plug 20 shown in FIG. 1B, and a bolt 30 (refer to FIG. 3A).

Here, the outer sleeve 10 and the inner plug 20 are manufactured from the synthetic resin with plasticity, elasticity, and elasticity in order that the smooth expansion action is enabled.

As shown in FIG. 1A, the outer sleeve 10 includes an outer sleeve body 11 having a cylinder-like shape, an outer sleeve flange 12 having a disc-like shape which is formed in an end face of the outer sleeve body 11 in one, and an outer sleeve expansion part 13 having a cone-like shape which is formed in another end face of the outer sleeve body 11 in one.

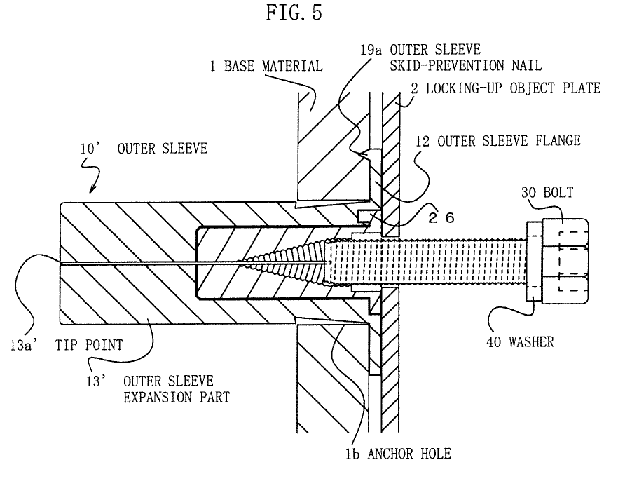

The reason why the outer sleeve expansion part 13 has the cone-like shape is for adding the self-drilling function to the outer sleeve 10. Therefore, when the self-drilling function is not added to the outer sleeve 10, an outer sleeve expansion part 13′ having a cylinder-like shape as shown in FIG. 5 may be used.

In order to add the self-drilling function to the elasticity material like the gypsum board, four outer sleeve drilling blades 15 (refer to FIG. 3B) are formed in the circumferential face of the outer sleeve expansion part 13, and an outer sleeve drilling spirally-concave-carved part 16 is formed from the boundary of the outer sleeve expansion part 13 and the outer sleeve body 11 to the central part of the outer sleeve body 11.

In addition, the outer sleeve drilling blades 15 can be manufactured by molding the outer sleeve expansion part 13 with a metal suitable for the drill blade edge in one, or by providing a pocket, which can equip with a blade, to the outer sleeve expansion part 13 in order that a disposable cutting edge can be inserted to the pocket.

In addition, when the self-drilling function to the elasticity material is not added to the outer sleeve 10, the outer sleeve drilling blades 15 and the outer sleeve drilling spirally-concave-carved part 16 are unnecessary.

In order that the outer sleeve expansion part 13 can be in the expansion state to demonstrate the anchor power effectively after equipping with the mechanical blind expansion board-anchor, the outer sleeve expansion part 13 is consisted of four pieces divided into four centering on the axis (refer to FIG. 3B). That is, in the outer sleeve expansion part 13, an outer sleeve slit 14 (refer to FIG. 3B) having the cross-joint shape in which a tip point 13a of the outer sleeve expansion part 13 is made the expansion starting point is formed along the axis.

The outer sleeve slit 14 is formed so that the termination of the outer sleeve slit 14 may reach the outer sleeve flange 12 side rather than the intermediate point of the outer sleeve body 11. The outer sleeve expansion part 13 is not limited to four pieces, but should just consist of two or more pieces.

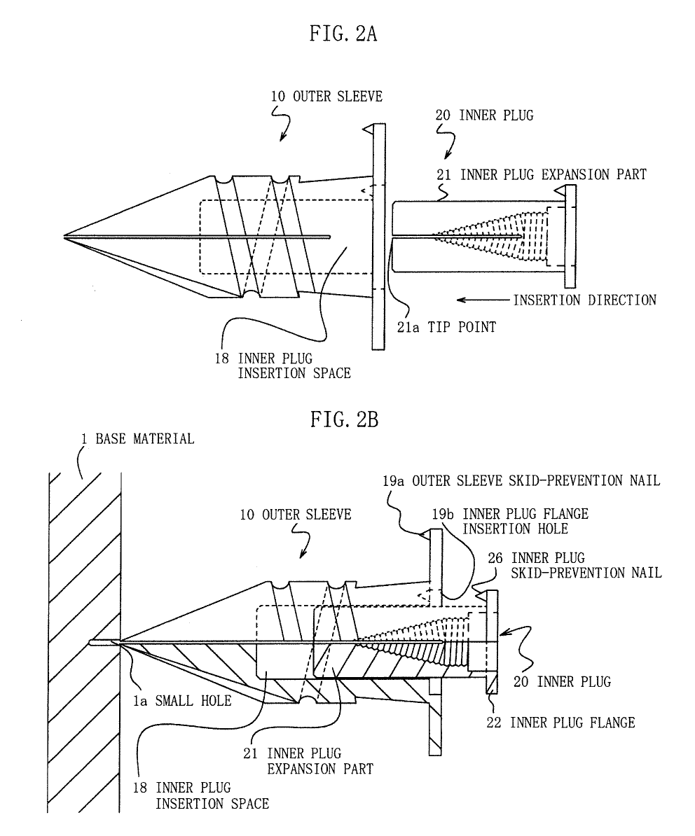

In order to sandwich the base-material 1 (refer to FIG. 2B) with the outer sleeve flange 12 after equipping the base-material 1 with the mechanical blind expansion board-anchor, an outer sleeve base-material anchoring stage part 17 is formed in the circumferential surface of the intermediate part of the outer sleeve body 11, and the diameter of the outer sleeve body 11 is reduced from the end face by the side of the outer sleeve flange 12 of the outer sleeve body 11 toward the outer sleeve base-material anchoring stage part 17.

An inner plug insertion space 18, the diameter of which is the almost same size as the diameter of an inner plug expansion part 21 (refer to FIG. 1B) of the inner plug 20 is formed from the end face by the side of the outer sleeve flange 12 of the outer sleeve body 11 toward the outer sleeve expansion part 13. Thereby, the perimeter side of the inner plug expansion part 21 touches the inner wall of the outer sleeve body 11 when the inner plug 20 is inserted in the inner plug insertion space 18, so that the tensile stress is demonstrated according to the surface resistance proof stress produced by the expansion of the mechanical blind expansion board-anchor.

The inner plug 20 is used by being inserted in the inner plug insertion space 18 of the outer sleeve 10, and includes, as shown in FIG. 1B, the inner plug expansion part 21 having the cylinder-like shape, and the inner plug flange 22 having the disc-like shape which is formed in an end face of the inner plug expansion part 21 in one.

In order that the inner plug expansion part 21 can be in the expansion state after equipping with the mechanical blind expansion board-anchor, the inner plug expansion part 21 is consisted of four pieces divided into four centering on the axis (Refer to FIG. 3B). That is, in the inner plug expansion part 21, an inner plug slit 23 having the cross-joint shape in which a tip point 21a of the inner plug expansion part 21 is made into the expansion starting point is formed along the axis.

The inner plug slit 23 is formed so that the termination of the inner plug slit 23 may reach the inner plug flange 22 side rather than the intermediate point of the inner plug expansion part 21. Moreover, the inner plug expansion part 21 is not limited to four pieces, but should just consist of two or more pieces.

In the inside of the inner plug expansion part 21, a female screw 24 is formed from the end face by the side of the inner plug flange 22 toward the tip point 21a side rather than the intermediate point of the inner plug expansion part 21.

Here, the female screw 24 is formed with having the cone-like shape the diameter of which is reduced from the end face by the side of the inner plug flange 22 towards the intermediate point of the inner plug expansion part 21.

Moreover, the female screw 24 is molded in the condition that the inner plug expansion part 21 is expanded, and the inner plug 20 is attached by shutting and inserting the inner plug expansion part 21 to the outer sleeve 10. Thereby, as the bolt screwing fastening progresses, the inner plug expansion part 21 is extensible with the nib rupture effect of the inner plug slit 23 from the tip point 21a (the expansion starting point end) of the inner plug expansion part 21, and reaches gradually to the maximum expansion position and transmits the expansion function to the outer sleeve 10.

In order to prevent the skid to the base material 1 when the bolt is screwed, an outer sleeve skid-prevention nail 19a is formed in the face by the side of the outer sleeve body 11 near the perimeter of the outer sleeve flange 12 as shown in FIG. 1A.

In order to prevent the skid to the inner plug 20 when the bolt is screwed, an inner plug skid-prevention nail 26 is formed in the face by the side of the inner plug expansion part 21 near the perimeter of the inner plug flange 22 as shown in FIG. 1B, and an outer sleeve skid-prevention concave part 19c is formed in the end face by the side of the outer sleeve flange 12 of the outer sleeve body 11 as shown in FIG. 1A.

Instead of forming the outer sleeve skid-prevention nail 19a, the inner plug skid-prevention nail 26, and the outer sleeve skid-prevention concave part 19c, a minimum right-angled triangular sleeve, which uses as the oblique side the straight line connecting one point of the outer sleeve flange 12 and one point of the outer sleeve body 11, is provided in the corner of the outer sleeve flange 12 and the outer sleeve body 11, a minimum right-angled triangular sleeve, which uses as an oblique side the straight line connecting one point of the inner plug flange 22 and one point of the inner plug expansion part 21, is provided in the corner of the inner plug flange 22 and the inner plug expansion part 21, and the positions of the base-material 1 and the outer sleeve 10 corresponding to these right-angled triangular sleeves are engraved with cut slots, to prevent the skid by inserting two sides other than the oblique side of these right-angled-triangle sleeves to the cut slots, respectively.

Although the outer sleeve 10 and the inner plug 20 are designed and manufactured with the dimension to stick, it is designed so that they break away at any time except the time of the expansion.

In the inner plug flange 22 and the end face by the side of the inner plug flange 22 of the inner plug expansion part 21, a hexagon-head-stick-wrench insertion concave part 25 (refer to FIG. 3C) for fastening the mechanical blind expansion board-anchor is formed. Thereby, since it is possible to work without the attachment exchange of an impact driver by using a bolt 30 having a hexagon-head-stick-wrench insertion concave part of the same size, the working hours can be shortened. In addition, the hexagon-head-stick-wrench insertion concave part 25 also serves as a bolt penetration hole for making the bolt 30 penetrate.

As shown in FIG. 1A, an inner plug flange insertion hole 19b in which the inner plug flange 22 is inserted is formed in the central part of the outer sleeve flange 12.

Next, the application method of the mechanical blind expansion board-anchor according to the embodiment will be described with reference to FIGS. 2-4.

First, as shown in FIG. 2A, the inner plug 20 is inserted in the inner plug insertion space 18 of the outer sleeve 10 from the tip point 21a of the inner plug expansion part 21. Then, as shown in FIG. 2B, the inner plug 20 is inserted so that the inner plug flange 22 of the inner plug 20 is inserted in the inner plug flange insertion hole 19b of the outer sleeve 10 and the inner plug skid-prevention nail 26 of the inner plug 20 is inserted in the outer sleeve skid-prevention concave part 19c of the outer sleeve 10.

Thereafter, as shown in FIG. 2B, after forming a small hole 1a for drilling guide in the base-material 1 which is the plate material, an anchor hole 1b is punched at the base material 1 by utilizing the self-drilling function of the outer sleeve 10.

In addition, when the outer sleeve 10 including the outer sleeve expansion part 13′ without the self-drilling function as shown in FIG. 5 is used, the anchor hole 1b is punched at the base material 1 using an exclusive drilling tool or a handsaw.

Thereafter, as shown in FIG. 3A, the outer sleeve 10 in which the inner plug 20 is inserted is inserted from the tip point 13a of the outer sleeve expansion part 13 in the anchor hole 1b punched at the base-material 1, until the face by the side of the base-material 1 of the outer sleeve flange 12 of the outer sleeve 10 contacts the surface of the base-material 1. After that, the outer sleeve skid-prevention nail 19a is penetrated into the base-material 1 by pressing or striking the outer sleeve skid-prevention nail 19a, for example.

Thereafter, a locking-up object plate 2 with a bolt hole is attached to the surface of the base-material 1. After a washer 40 is attached to the bolt 30, the bolt 30 is penetrated from the tip of the screw into the hexagon-head-stick-wrench insertion concave part 25 formed in the inner plug flange 22 and the inner plug expansion part 21, and then the bolt 30 is inserted until the tip of the screw of the bolt 30 hits the female screw 24. After that, the screwing of the bolt 30 is carried out. Then, the skid can be prevented, because the outer sleeve skid-prevention nail 19a is penetrating into the base-material 1 and the inner plug skid-prevention nail 26 is inserted in the outer sleeve skid-prevention concave part 19c of the outer sleeve 10.

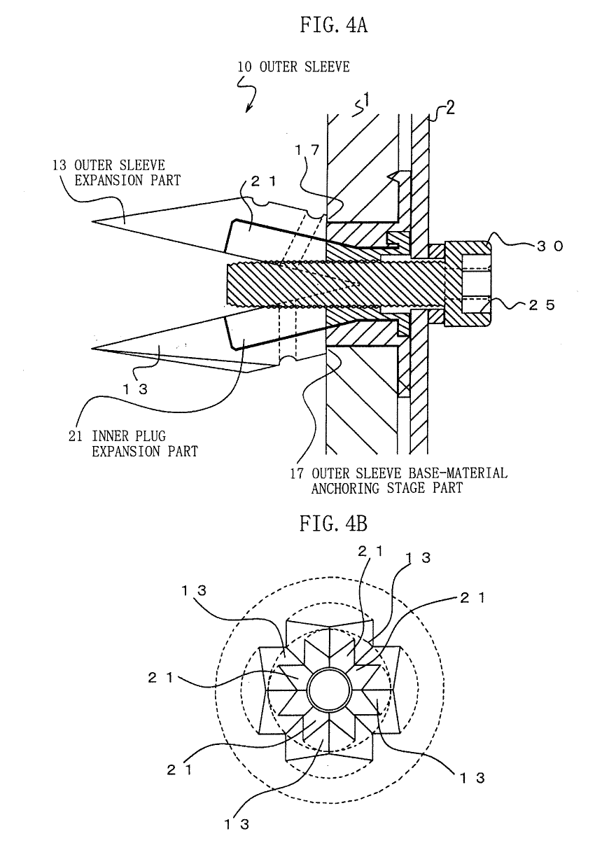

When the screwing of the bolt 30 is carried out, the female screw 24 can extend gradually by the tip of the screw of the bolt 30, so that the inner plug expansion part 21 expands gradually. Thereby, the outer sleeve expansion part 13 can extend gradually by the inner plug expansion part 21, so that the outer sleeve expansion part 13 expands gradually. As a result, as shown in FIG. 4A, since the outer sleeve base-material anchoring stage part 17 can also expanded so that the base-material 1 can be pushed, it can abolish that the outer sleeve 10 and the base-material 1 carry out grumblingly in the sandwiches action with the outer sleeve flange 12.

When the screwing of the bolt 30 is carried out further, as shown in FIGS. 4A and 4B, the tip of the screw of the bolt 30 runs through the tip point of the female screw 24 completely, and the inner plug expansion part 21 extends the outer sleeve expansion part 13 to the maximum aperture, thereby the expansion action is completed. After that, since the inner plug 20 moves to the base-material 1 side when the screwing fastening of the bolt 30 is carried out slightly, the expansion anchor effect can be made more reliable. However, it is important to do this screwing fastening work carefully and to make it not impose the brake torque as much as possible.

FIGS. 2-4 show an example when using the base material 1 of 12.5 mm of gypsum board thickness. When the distance between the anchor holes 1b is set corresponding to the thickness of each base material (plate material), the present invention can be broadly used from the split plate like the sheet steel to the plate material such as 30-100 mm of styrene foam.

Above, the example in which the bolt fixed over the wall rose perpendicularly like the base-material 1 is shown. However, since the mechanical blind expansion board-anchor of the present invention acquires the proof stress also to the hanging normal load, it is utilizable also for the light direct attachment to the head lining. Furthermore, when the heavy load is hung, the future construction of the dovetail anchor which we propose in JP-A-2007-46229 is carried out to the ceiling slab or the beam concrete, and after reinforcing the sheet-steel flat bar or the angle at the reverse side of the board, the mechanical blind expansion board-anchor of the present invention is used, and the instrument is hung and locked up.

The tension test value of the dovetail anchor which we propose in JP-A-2007-46229 is shown below.

Anchor conditions: Ordinary-structural rolled steel (SSJIS G 3101)
1. Drilling depth 40 mm
2. Anchor outer depth 30 mm
3. Anchor outer dimension 30×60×t=2 Two right-and-left
4. Anchor inner dimension (46 to 48)×(26 to 30)×t=4.5 Four sheets
(a) A concrete (sample-under-test dimension: 150×150×100 mm) non-reinforcing steel
[Result] 27.2 KN/M12-bolt

Base-material crack destructive situation: The 2nd page of the crack to the direction of the dovetail partition extension surface on the basis of the side of the dovetail, and the intersection of the bottom, and the recess break-down to the side.

(b) Diorite (sample-under-test dimension: 182×152×117 mm)
[Result] 40.0 KN/M12-bolt

Base-material crack destructive situation: The 1st page of crack break-down to the direction of the dovetail partition extension surface on the basis of the side of the dovetail, and the intersection of the bottom.

If the dovetail which has the angle of gradient to the base-material surface can be punched even if perpendicular, even when the above-mentioned test result has the level base-material concrete which is anchor installation surface, also physically and structurally it can pull up and there cannot be no accident. Therefore, since the design of the anchor bolt and strength calculation are attained only with the above-mentioned test value, the drawing examination after the real construction in the spot becomes unnecessary.

That is, the maximum tenacity of the expansion anchor may become the lower value of the base-material strength and the bolt yield point strength.

Super-high strength material is adopted as the base material itself, using the base material fully reinforced by the base material (plate material). Moreover, the outer sleeve 10 and the inner plug 20 are manufactured using a super-high strength engineering plastic. If it combines with the super-high-strength-steel bolt which reaches 800 mega Pascal, a fast super-high strength board-anchor is realizable.

Although the explanation so far used form of the inner plug 20 as the cylinder, you may use it as a square pillar. In this case, the form of the inner plug insertion space 18 of the outer sleeve 10 is also made into the shape of a square pillar. Moreover, the inner plug skid-prevention nail 26 and the outer sleeve skid-prevention concave part 19c become unnecessary.

Materials, such as a gypsum board used for an actual building, make nonflammability or fire retardancy material engine-performance conditions. Therefore, a nonflammable fire-resistant engine performance can be given by manufacturing the mechanical blind expansion board-anchor of the present invention with nonflammable materials, such as a glass fiber strengthening plastic.

In order to gain economically the most important fire-resistant engine performance and strength, manufacture by metal materials, such as steel, is desirable. Because an expansion action is one-time movement which is not repeatedly, I think that the manufacture by elastic metal is easy.

1. A mechanical blind expansion board-anchor comprising:
an outer sleeve including an outer sleeve body, an outer sleeve flange formed in an end face of the outer sleeve body, and an outer sleeve expansion part formed in another end face of the outer sleeve body;
an inner plug including an inner plug expansion part, and an inner plug flange formed in an end face of the inner plug expansion part; and
a bolt
wherein an inner plug insertion space, into which the inner plug is inserted, is formed in the outer sleeve body of the outer sleeve;
a female screw part, a diameter of which is reduced from the end face by a side of the inner plug flange of the inner plug expansion part toward a tip part of the inner plug expansion part, is formed inside of the inner plug expansion part of the inner plug; and
the inner plug expansion part is expanded by inserting the inner plug in the inner plug insertion space of the outer sleeve, inserting a screw part of the bolt in the female screw part of the inner plug, and screwing the bolt, thereby the outer sleeve expansion part is expanded.

2. The mechanical blind expansion board-anchor according to claim 1, wherein the mechanical blind expansion board-anchor is made from glass-reinforced plastics.

3. The mechanical blind expansion board-anchor according to claim 1, wherein
the outer sleeve expansion part has a cone-like shape;
an outer sleeve drilling blade is formed in a circumferential face of the outer sleeve expansion part; and
an outer sleeve drilling spirally-concave-carved part is formed from a boundary of the outer sleeve expansion part and the outer sleeve body to a central part of the outer sleeve body.

4. The mechanical blind expansion board-anchor according to claim 1, wherein
an outer sleeve base-material anchoring stage part is formed in a circumferential surface of an intermediate part of the outer sleeve body; and
a diameter of the outer sleeve body is reduced from the end face by a side of the outer sleeve flange of the outer sleeve body toward the outer sleeve base-material anchoring stage part.

5. The mechanical blind expansion board-anchor according to claim 1, wherein an outer sleeve skid-prevention nail is formed in a face by a side of the outer sleeve body of the outer sleeve flange.

6. The mechanical blind expansion board-anchor according to claim 1, wherein
an inner plug skid-prevention nail is formed in a face by a side of the inner plug expansion part of the inner plug flange;
an inner plug flange insertion hole, in which the inner plug flange is inserted, is formed in the outer sleeve flange; and
an outer sleeve skid-prevention concave part, in which the inner plug skid-prevention nail is inserted, is formed in an end face by a side of the outer sleeve flange of the outer sleeve body.

7. (canceled)
